(19) United States
(12) Patent Application Publication
(10) Pub. No.: US 2003/0217758 A1
(43) Pub. Date: Nov. 27, 2003

(54) Method of and system for affixing images to fingernails

(76) Inventor: Laurence Mesirow, Chicago, IL (US)

Correspondence Address: WINSTON & STRAWN, PATENT DEPARTMENT, 1400 L STREET, N.W., WASHINGTON, DC, 20005-3502, US

(21) Appl. No.: 10/153,281

(22) Filed: May 21, 2002

(51) Int. Cl. B26B 13/22

(52) U.S. Cl. 132/73.5

(57) ABSTRACT

The present invention provides a system for affixing a custom image to an artificial fingernail. The system comprises a memory for storing the image, a processor operatively coupled to the memory and a printer operatively coupled to the processor. The processor is configured to obtain the image from the memory and cause the printer to print the image on a material. The material with the image printed thereon is attached to the artificial fingernail using an adhesive. In addition, a method of affixing a custom image to an artificial fingernail is provided. The method comprises the steps of obtaining the image, printing the image on a material and affixing the material with the image printed thereon to the artificial nail using an adhesive.

### BACKGROUND

1. Field of the Invention

The present invention relates to a method of and system for affixing images or other designs to fingernails.

2. Description of the Prior Art

A variety of methods and systems are known for affixing images to fingernails.

For example, U.S. Pat. No. 5,975,087 to Jang discloses a method through which a user can attach pre-fabricated pictures or patterns to natural fingernails or artificial nails. U.S. Pat. No. 5,778,900 to Bate discloses a method of decorating fingernails through a number of steps which include applying a piece of decorated nail paper to a fingernail.

The prior art, however, has proven unsatisfactory in that it does not provide a way to affix customized images to fingernails. Conventional prior art methods require the images to be pre-fabricated and, therefore, do not enable the images to be customized by the user. Thus, a customer who walks into a manicure shop with a desire to apply an image to one or more of her fingernails is limited to the specific images available at that particular shop. The customer would be unable, for example, to affix an image of a loved one to a fingernail.

Accordingly, it is clear that there exists a need for a method of and a system for attaching custom images to fingernails.

### SUMMARY OF THE INVENTION

Accordingly, it is an object of the present invention to provide a system for affixing custom images to fingernails. It is another object of the present invention to provide a method of affixing custom images to fingernails. Other objects of the present invention will become apparent from the following discussion.

In accordance with one embodiment of the present invention, a system is provided for affixing a custom image to an artificial fingernail. The system comprises a memory for storing the image, a processor operatively coupled to the memory and a printer operatively coupled to the processor. The processor is configured to obtain the image from the memory and cause the printer to print the image on a material. The material with the image printed thereon is attached to the artificial fingernail using an adhesive.

In accordance with another embodiment of the present invention, a method of affixing a custom image to an artificial fingernail is provided. The method comprises the steps of obtaining the image, printing the image on a material and affixing the material with the image printed thereon to the artificial nail using an adhesive.

It is to be understood that both the foregoing summary and the following detailed description of the present invention are exemplary and are intended to provide a description of, and not limit, the present invention.

The present invention will now be described in greater detail, with frequent reference being made to the drawings identified below.

### BRIEF DESCRIPTION OF THE DRAWINGS

In the accompanying drawings:

FIG. 1 is a block diagram of a system in accordance with one embodiment of the present invention;

FIG. 2 is a flow chart which illustrates the operation of the system of FIG. 1;

FIG. 3 is a block diagram of a software application in accordance with one embodiment of the present invention; and

FIG. 4 illustrates an image being affixed to a fingernail in accordance with one embodiment of the present invention.

### DETAILED DESCRIPTION OF THE PREFERRED EMBODIMENT(S)

The following description is presented to enable any person of ordinary skill in the art to make and practice the present invention. Modifications to the preferred embodiment will be readily apparent to those of ordinary skill in the art, and the disclosure set forth herein may be applied to other embodiments and applications without departing from the spirit and scope of the present invention and the appended claims. Thus, the present invention is not intended to be limited to the embodiments described, but is to be accorded the broadest scope consistent with the claims appended hereto and the disclosure set forth herein.

The present invention relates generally to improving the aesthetics of fingernails. In particular, and without limitation, the present invention relates to artificial nails (as used herein, the term “artificial nails” includes acrylic fingernails and fingernails made of other materials, which can be affixed or otherwise attached to natural fingernails) having images (as used herein, the term “image” includes any visual data, including without limitation drawings, photographs, pictures, designs, etc.) thereon which are applied to natural fingernails.

The present invention will generally be used in manicure shops. However, those of ordinary skill in the art will appreciate that the present invention is not limited to use in manicure shops, but may be used anywhere, including in a home.

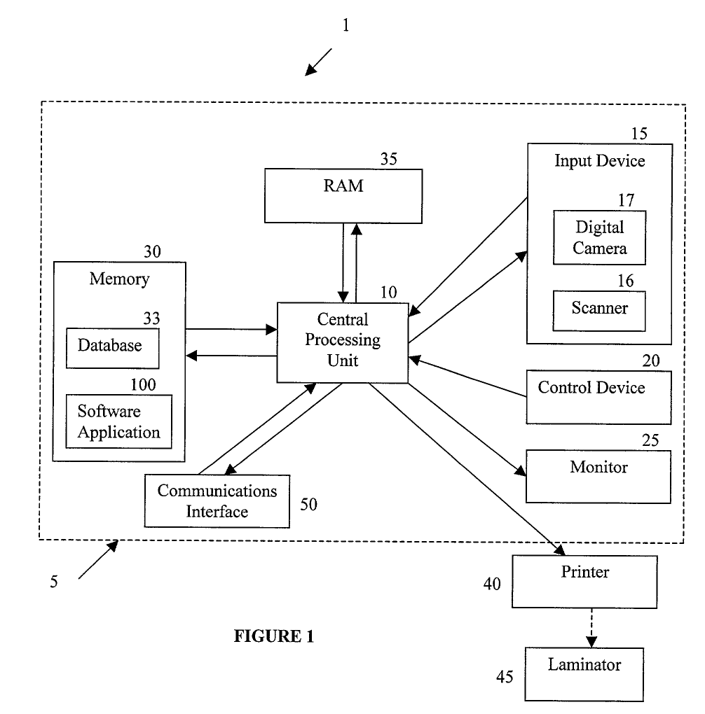

Referring now to the drawings, FIG. 1 is a block diagram of a system 1 in accordance with one embodiment of the present invention. The system 1 includes a computer 5 which will typically comprise a central processing unit 10 (CPU) for controlling the operation of the computer 5, an input device 15 operatively coupled to the CPU 10, such as a scanner, digital camera, floppy drive, tape drive, CD-ROM drive, DVD drive, computer network interface, etc., or any combination thereof, for inputting image data into the computer; a control device 20, such as a keyboard and/or mouse, for allowing a user to control the operation of the system 1 and input information; a monitor 25 for system output display; a memory 30, such as a hard disk drive or tape drive or other memory device, operatively coupled to the CPU 10 for storing the software application which will be used to control the system and image data; and a random-access-memory (RAM) 35 which may be used in addition to or in combination with the memory 30 to store image data or other information. The computer 5 may also include a communications interface 50, such as a modem or network card, which can be used to communicate with other computers and computer networks for image data exchange or database updates. The system also includes a printer 40 operatively coupled to the CPU 10 for printing the image which will be attached to the artificial nails. The system may also include a laminator 45 for laminating the image printed by the printer 40.

Referring to the input device 15, the input device 15 may include a scanner 16 which enables a system user to scan any desired image into the system for customization, as described in greater detail below. The input device 15 may further include a digital camera 17 in addition to or in lieu of the scanner 16 for taking pictures and uploading them to the memory 30.

Referring to the memory 30, the memory 30 includes a software application 100 which is used by system users to control the operation of the system 1. The memory 30 also includes a database 33 which may be used to store scanned-in images or images taken by the digital camera 17. The database 33 may also be used to store pre-made images. If the system is being used in a manicure or other shop, the database 33 can be organized by customers' names, thereby facilitating use of the system for particular customers. Alternatively, the database 33 can be stored on a network in a central computer, thereby enabling local computers, such as the computer 5, to exchange pictures and other images through the communications interface 50.

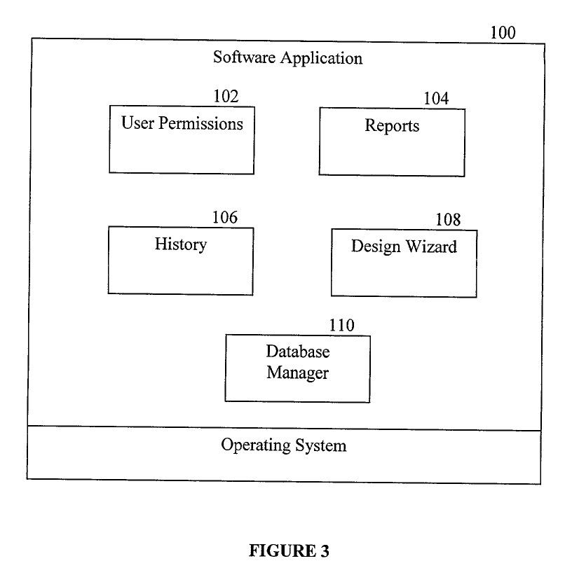

Referring to FIG. 3, in a preferred embodiment, the software application 100 is installed on a Microsoft Windows platform, such as Windows 95, Windows 98 or Windows 2000 operating system, and includes a number of different modules: a User Permissions module 102, a Reports module 104, a History module 106, a Design Wizard module 108, and a Database Manager 110.

The User Permissions module 102 incorporates various security features used throughout the software application. For example, each user can be assigned a login name and a password associated with the login name to access the system 1. This allows the system to monitor and track system usage, and to associate permitted usages with each user. For example, a specific user may only be granted access to a particular database, thus enabling the user to view only certain images associated with his/her login name.

The Reports module 104 enables the generation of system usage reports. For example, daily reports may be generated which reflect system usage for each particular day. Reports may also be customized to fit the particular needs of system users. For example, a system user can generate a report reflecting the user's activity over a specific period of time. A system user can also generate a report which contains a list of the most popular images used by system users during a specific time period. Reports may also be generated for a particular customer reflecting the images selected by the customer over a specific period of time. In a preferred embodiment, the reports can be saved to memory, such as a hard disk or floppy disk, and printed on the printer.

The History module 106, in connection with the Database Manager 110, allows customers to view their past image choices. The History module 106 may also keep track of each customer's visits to the shop and based on past choices may recommend other images which other customers found to be interesting and pleasant to the eye. The recommending feature might be implemented as a separate module if desired.

The Design Wizard module 108 allows stored image files to be manipulated, sized, positioned and then named as a design template. Preferably, the Design Wizard does not limit the amount of design templates that can be saved and accessed.

The Database Manager 110 manages the images stored in the database 33. In a preferred embodiment, images in the database 33 are assigned a number or other identifier and stored as part of a record that may include other desired fields, such as customer name, address, telephone number, date created, design format, etc. Microsoft Access, or any other database management program, may be used as the Database Manager 110.

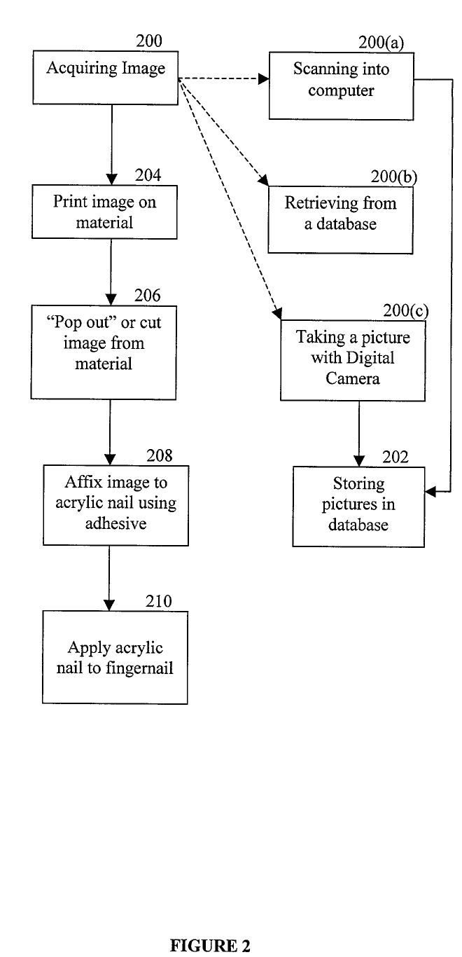

Referring to the flow chart of FIG. 2, the operation of the system 1 of FIG. 1 is described.

The first step 200 is to acquire the image (or images) to be applied to the artificial nail. The image can be scanned in using the scanner 15 (step 200(a)), retrieved from the database 33 (step 200(b)) or obtained using the digital camera 17 (step 200(c)). If the image is scanned in or obtained using the digital camera, the image is preferably stored in the database 33 for future reference and use (step 202). The image can also be obtained from a floppy disk, CD-ROM, etc. The use of scanners and digital cameras to acquire images is well known and need not be described herein in detail. Generally, an image is placed into a scanner which is connected to a computer. The scanner can be operated through the computer using typical scanning software. The acquired image can then be saved to computer's memory from which point it can be accessed by the software application 100. Similarly, a digital camera can either save recently taken images to a memory card and then transfer the image to the computer or instantly transfer the image to the computer and save it in the computer's memory. The foregoing process can be repeated as necessary if a number images will be used.

Once the desired image is obtained, it is sized and oriented as desired using the Design Wizard 108 and then printed on a material (step 204) which will be applied to the artificial nail. In situations where multiple images are being used for different nails or the same image is being used on multiple nails, all of the images can be sized and oriented first and then printed at the same time, or the process can proceed serially, with each image being sized, oriented and printed in turn.

In a preferred embodiment, the material is a plastic material, although it can be any suitable material. The material should be both receptive to printed images and flexible enough to be fitted around acrylic nails. While the material should be thin, it should be thick enough to cover imperfections on the artificial nails and withstand the stress induced by the adhering process, as described below. A thickness of approximately 1 mm should generally be satisfactory.

The material preferably takes the form of sheets which are the size of credit or identification cards (e.g., 2.15″×3.43″). Each sheet has five sets of pre-cut nail shapes which correspond in size to each of the five fingernails on a person's hand and can be “popped out” of the sheet for application to the artificial fingernails. Material which can be used includes polyvinylchloride (PVC), teslin or acetate.

Once the desired images are printed on the nail shapes (see below) (step 204), the shapes are “popped out” (step 206) and applied to artificial nails through the use of an adhesive (step 208). The artificial nails with the images thereon are then applied to the natural fingernails (step 210). Alternatively, the customer may already have acrylic nails applied to her fingernails, in which case this last step is unnecessary.

In another embodiment, the material can be self-adhesive and either pre-cut or diecut to be applied to the designated artificial nail. In this embodiment, for best performance, the material should be manufactured in a manner which enables it to be peeled from a backing no less than 10 millimeters in thickness. Two materials which satisfy these requirements are PVC (polyvinylchloride) and teslin blank white cards. If diecutting is used, the diecutter can be a standard tabletop PVC type, custom made to fit the size specifications for the artificial nails to which the images will be applied. Once the image is diecut, the printed surface is peeled from the backing and adhered to the artificial nail.

To print the images on the plastic material, a color laser printer or other suitable printer can be used. The material is inserted into the printer, and the printer prints the desired images on the appropriate locations on the material. The laminator 45 can then be used, if desired, to put a protective plastic laminate over each image. In another embodiment, a portable die sublimation printing process can be used with a heat controlled print head, which melts a thin coat of plastic film over the image to preserve it. The printer 40 can use a 5-panel ribbon (YMCKO—350 prints per ribbon), which takes 25 seconds per print. Because of the protection provided by the thin, clear over laminate, the film is immediately available to be diecut. A pre-cut sheet will generally not be used if an over laminate is desired since the laminate will prevent the nail shapes from being “popped out”.

Once the images are “popped out” or die cut from the plastic sheet, they are applied to the artificial nails. In a preferred embodiment, an adhesive can be used to affix the images to the acrylic nails. Any suitable adhesive may be used. Adhesives are well known in the artificial nail industry and are commercially available. If the images are self-adhesive, then the use of a separate adhesive is not necessary. If desired, a base polish can be applied to the acrylic nails prior to adherence of the images and a final over-coat can be applied for waterfastness and waterproofing.

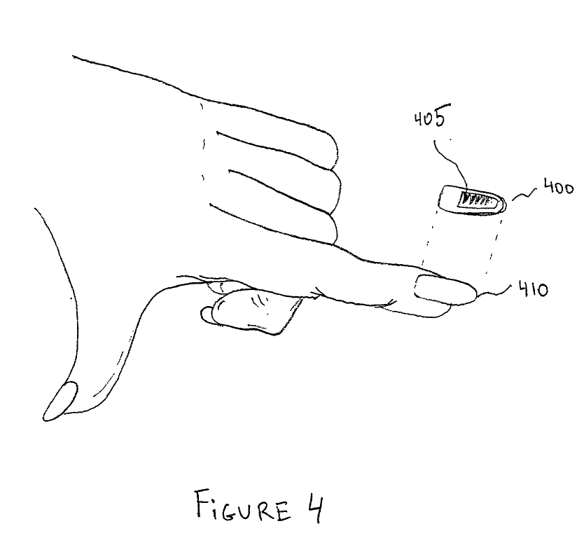

Referring to FIG. 4, an artificial nail 400 with an image 405 affixed thereto is applied to a fingernail 410 in accordance with an embodiment of the present invention.

As indicated above, the present invention will typically be used in a manicure salon. However, those of ordinary skill in the art will appreciate that the present invention is not limited to use in a nail salon. For example, the present invention may be used in a home setting to create customized artificial nails.

Those of ordinary skill in the art will further appreciate that the present invention is not limited to any particular software application or any particular Windows™ environment. Instead, those skilled in the art will find that the system and methods of the present invention may be advantageously applied using a variety of system and applications software, including graphics software, image-editing software, and the like. Moreover, the present invention may be used on a variety of different operating systems, including Windows, Macintosh, UNIX and the like. Thus, those of ordinary skill in the art will appreciate that the present invention is not limited to the operating system and applications software specifically discussed herein.

It will be apparent to those skilled in the art that various modifications and variations can be made in the method and system of the present invention without departing from the spirit or scope of the invention. Thus, it is intended that the present invention include modifications and variations that are within the scope of the appended claims.

I claim:

1. A system for affixing a custom image to an artificial fingernail, said system comprising:
a memory for storing said image;
a processor operatively coupled to said memory; and
a printer operatively coupled to said processor;
said processor being configured to obtain said image from said memory and cause said printer to print said image on a material;
wherein said material with said image printed thereon is attached to said artificial fingernail using an adhesive.

2. The system of claim 1, wherein said image is a photograph.

3. The system of claim 1, further comprising a scanner for inputting said image into said memory.

4. The system of claim 1, further comprising a digital camera for obtaining said image and inputting said image into said memory.

5. The system of claim 1, wherein said image is stored in an image database in said memory.

6. The system of claim 1, wherein said material is a plastic material.

7. A method of affixing a custom image to an artificial fingernail, said method comprising the steps of:
obtaining said image;
printing said image on a material; and
affixing said material with said image printed thereon on said artificial nail using an adhesive.

8. The method of claim 7, further comprising the step of applying said artificial nail with said image affixed thereto to a fingernail.

9. The method of claim 7, wherein the obtaining step further includes the step of scanning said image into a computer.

10. The method of claim 7, wherein the obtaining step further includes the step of obtaining said image with a digital camera and uploading said image into a computer.

11. The method of claim 7, wherein said material is a plastic material.

12. The method of claim 7, wherein said image is a photograph.

13. The method of claim 7, wherein said image is stored in an image database in said memory.
